(19) United States
(12) Patent Application Publication
(10) Pub. No.: US 2005/0216405 A1
(43) Pub. Date: Sep. 29, 2005

(54) Method for managing card-approval-information using memory address and credit-card system using that

(76) Inventor: Jin-Soo So, Seoul (KR)

Correspondence Address: CANTOR COLBURN, LLP, 55 GRIFFIN ROAD SOUTH, BLOOMFIELD, CT, 06002, US

(21) Appl. No.: 10/519,297

(22) PCT Filed: Jun. 23, 2003
(86) PCT No.: PCT/KR03/01225

§ 371 Date: Dec. 22, 2004

(30) Foreign Application Priority Data
Jun. 24, 2002 (KR) 10-2002-0035376

(51) Int. Cl. G06F 17/60

(52) U.S. Cl. 705/41

(57) ABSTRACT

A method for managing card-approval-in-formation using a memory address and a credit-card system using the method are provided. The method includes dividing a memory area, which has a predetermined size and used for storing card-approval-information and user attribute information, into a plurality of unit memory sections having a predetermined size and allocating a logical address to each of the unit memory section; generating and allocating a unique card number to a card, selecting a logical address of each unit memory section in order, and allocating the selected logical address to the card as a management number, while initially issuing or reissuing the card; generating a management table for managing a relationship between the management number and the card number and storing the management number and the card number in a memory chip of the card; storing card-approval-information download attribute information of the card in a unit memory section corresponding to the management number of the card; and generating a card-approval-information download message including a start address of the memory area and data stored in the memory area and transmitting the card-approval-information download message to terminal apparatuses and a predetermined system, which require the card-approval-information.

### TECHNICAL FIELD

The present invention relates to a method for managing card-approval-information and a credit-card system using the method, and more particularly, to a method for managing card-approval-information using a management number (for example, an Alias number), which is allocated to a card when the card is issued by a card company, and a credit-card system using the method

### BACKGROUND ART

Recently, a traditional method of collecting transport fares in cash or token has been changed into a method of collecting transport fares using a prepay card or postpay credit card settlement method based on a radio frequency (RF) method.

A transport fare collection method using an RF card makes a passenger feel free from a burden of necessity of carrying cash when using a public transportation and remarkably reduces a time taken for collecting a transport fare. In particular, a postpay RF credit card removes an inconvenience of a prepay method requiring refilling of an amount in advance to use and functions as both a credit card and a transport card, and thus is gaining public favor.

Since a postpay card method is based on a check of black list (BL) data during a collection or settlement, it is necessary to install a BL data storage module at each card terminal and periodically update BL data. As an updating period of the BL data becomes shorter, fares or charges can be more accurately collected.

However, when the BL data in the BL data storage module of each card terminal is updated, it takes a large amount of time to transmit new BL data to each card terminal.

For example, when 1,000,000 BL cards having poor credit information are recorded in a BL database (DB), since a data size of a single BL card number is 16 bytes (16 digits where a single digit takes 1 byte), a total size of the BL DB is 16 Mbytes. Accordingly, it takes about 55 minutes to download BL data from an aggregate computer to a card terminal in a conventional automatic fare collection system in which a communication line between the aggregate computer and the card terminal has a transmission rate of 38,400 bps. This result is obtained at an ideal maximum transmission speed. Actually, it takes average 15 minutes to transmit 100,000 bytes, and therefore, it takes about 150 minutes to transmit the 1,000,000-byte BL data.

When the BL data is directed transmitted from a central computer to the card terminal, a transmission rate is 19,200 bps, half of the transmission rate between the aggregate computer and the card terminal. In this case, it takes about 300 minutes to complete a download of the BL data.

Such a transmission time of BL data is considered as being a great amount of time in an automatic subway or railway fare collection system. Generally, a suspension time of the subway or railway service is only two or two and a half hours each day. Moreover, in addition to the BL data to a card terminal of a gate, the aggregate computer needs to process many types of information, such as station information related to service times, a discount rate application table, a fare table, and a station code table.

When the communication line is occupied during a download of the BL data from the aggregate computer to the card terminal, other jobs cannot be executed. Resultantly, only a small amount of time is allowed for data communication between the aggregate computer and the card terminal other than the download of the BL data, and therefore, it is difficult to manage a subway or railway service system.

Moreover, since the BL data has a property of increasing in size over time, it is anticipated that a transmission time of the BL data from he central computer or the aggregate computer to the card terminal increases gradually.

In the meantime, recently card companies allocate a management number (for example, an Alias number) as well as a card number to a card when issuing the card and manage both the management number and the card number. Unlike the card number, the management number is a serial number. The above-described problems of BL data transmission can be solved by using the characteristic of the management number in the postpay card method.

### DISCLOSURE OF THE INVENTION

The present invention provides a method for managing card-approval-information using a management number (for example, an Alias number) additionally allocated to a card when a card company issues the card, and a credit-card system using the method.

According to an aspect of the present invention, there is provided a method for managing card-approval-information. The method includes dividing a memory area, which has a predetermined size and used for storing card-approval-information and user attribute information, into a plurality of unit memory sections having a predetermined size and allocating a logical address to each of the unit memory section; generating and allocating a unique card number to a card, selecting a logical address of each unit memory section in order, and allocating the selected logical address to the card as a management number, while initially issuing or reissuing the card; generating a management table for managing a relationship between the management number and the card number and storing the management number and the card number in a memory chip of the card; storing card-approval-information and user attribute information of the card in a unit memory section corresponding to the management number of the card; and generating a card-approval-information download message including a start address of the memory area and data stored in the memory area and transmitting the card-approval-information download message to terminal apparatuses and a predetermined system, which require the card-approval-information.

According to another aspect of the present invention, there is provided a credit-card system using card-approval-information having a memory address. The credit-card system includes a central computer, which is connected to a server system of a card company through Internet and/or a private line, receives poor credit information and card-approval-information having a memory address from the server system, and stores and manages them in a separate storage place; and a card terminal, which receives the poor credit information and the card-approval-information having the memory address from the central computer, stores and manages them in a separate storage place, generates radio waves to communicate with a card approaching within a predetermined distance therefrom, and determines validity or invalidity of the card approaching thereto based on the poor credit information, the card-approval-information having the memory address, and card information obtained via the communication with the card.

Preferably, the credit-card system further includes a aggregate computer, which is connected to the central computer and the card terminal through the Internet and/or the private line, receives the poor credit information and the card-approval-information having the memory address from the central computer, stores and manages them in a separate storage place, transmits them to the card terminal, and transmits a result of processing performed by the card terminal to the central computer.

### BRIEF DESCRIPTION OF THE DRAWINGS

FIG. 1 is a flowchart of a method for managing card-approval-information using a memory address, according to an embodiment of the present invention.

FIGS. 1A through 1F show examples of memory and message formats used in the method for managing card-approval-information using a memory address according to the embodiment of the present invention.

FIG. 2 is a block diagram of a credit-card system according to an embodiment of the present invention.

FIG. 3 is a block diagram of a card terminal of the credit-card system according to the embodiment of the present invention.

FIGS. 4 through 7 are flowcharts showing an operation of the card terminal according to the embodiment of the present invention.

### BEST MODE FOR CARRYING OUT THE INVENTION

Hereinafter, embodiments of the present invention will be described in detail with reference to the attached drawings.

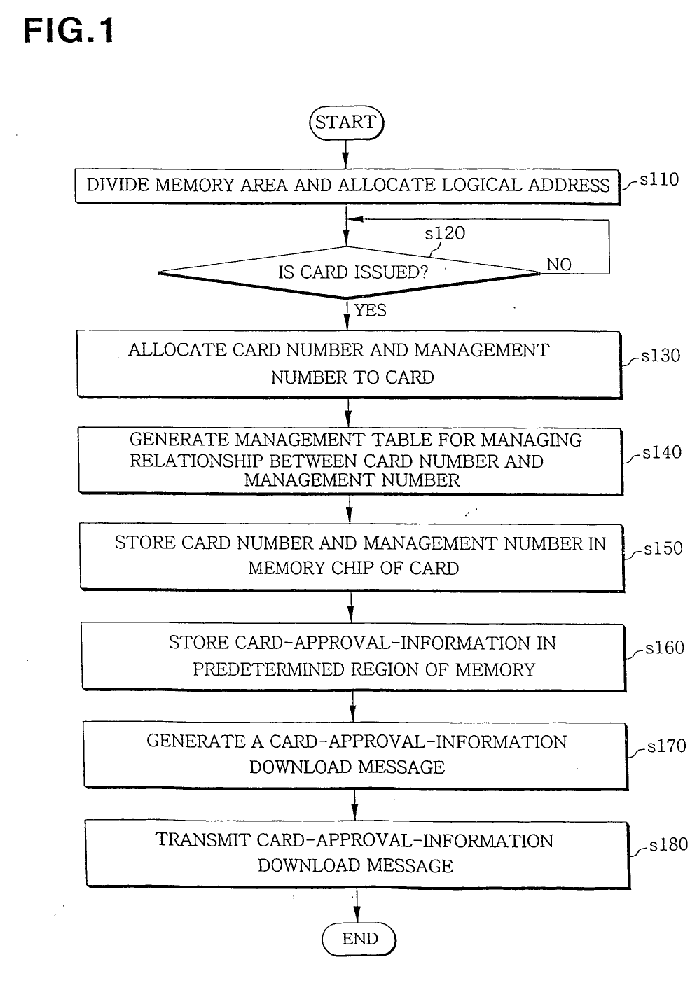

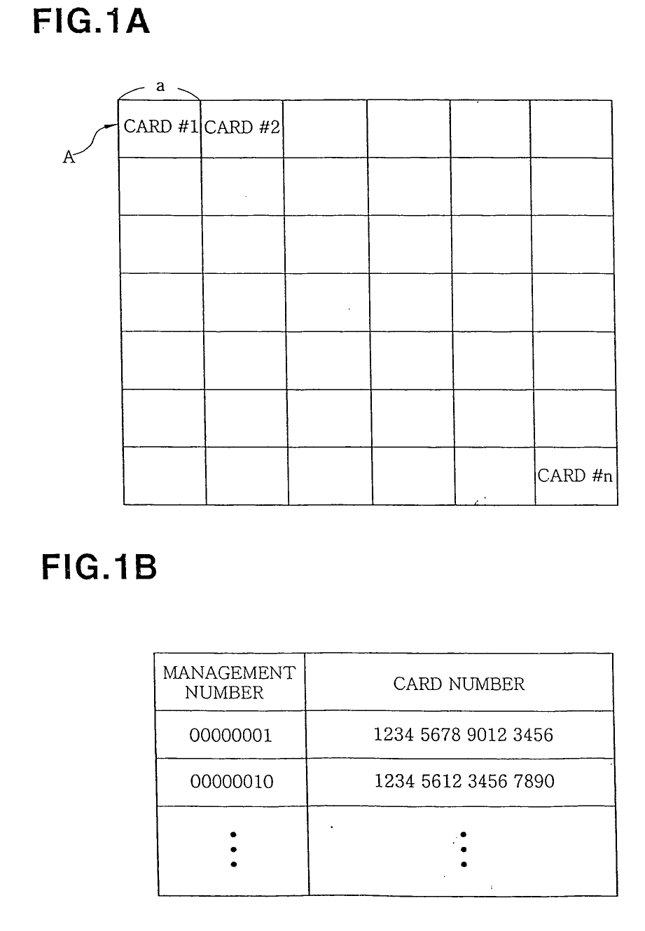

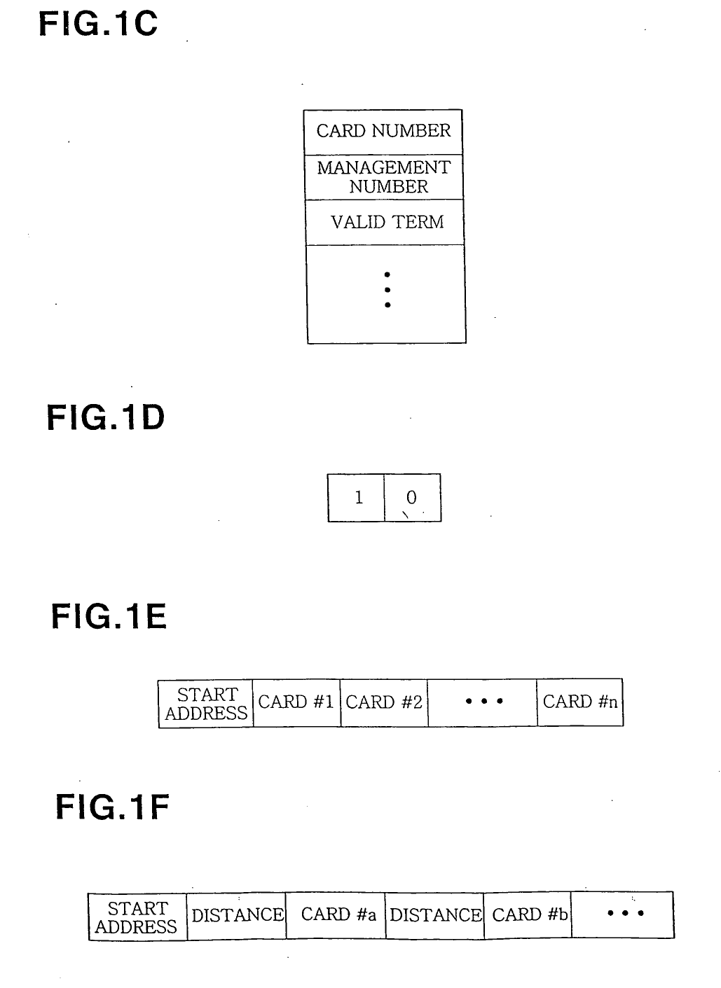

FIG. 1 is a flowchart of a method for managing card-approval-information using a memory address, according to an embodiment of the present invention. Referring-to FIG. 1, a memory area, which stores each card's approval information and card user's attributes, is divided into unit memory sections having a predetermined size, and a logical address is allocated to each unit memory section (S110). FIG. 1A is a diagram of a structure of the divided memory area. A predetermined memory area is set to store card-approval-information, and the predetermined memory area is divided into unit memory sections having a predetermined size “a”, as shown in FIG. 1A. When a start number is represented by “A” and a size of each unit memory section is represented by “a”, an actual address of a “logical address 1” is “A”, an actual address of a “logical address 2” is “A+a”, and an actual address of a “logical address 3” is “A+ax2”. Accordingly, a logical address and an actual address are related by Formula (1).
Actual address of logical address “n”=A+a(n−1) (1)

When a card is initially issued or reissued, a unique card number is generated and allocated to the card, and a logical address of a unit memory section selected in order is allocated as a management number to the card (S120 and S130). In FIG. 1A, a management number of a first card is “1”, a management number of a second card is “2”, and a management number of a third card is “3”. An actual address of each management number can be calculated using Formula (1).

A management table for managing a relationship between the management number and the card number of each card is generated (S140). An example of the management table is shown in FIG. 1B. Referring to FIG. 1B, a management number i.e., a logical address) “00000001” is used to manage information of a card number “1234 5678 9012 3456”, and a management number “00000010” is used to manage information of a card number “1234 5612 3456 7890”. In other words, card-approval-information and user attribute information corresponding to the card number “1234 5678 9012 3456” are stored and managed in a unit memory section corresponding to the logical address “00000001”, and card-approval-information and user attribute information corresponding to the card number “1234 5612 3456 7890” are stored and managed in a unit memory section corresponding to the logical address “00000010”.

The management number and the card number are stored in a memory chip of the card (S150). FIG. 1C shows an example of a memory structure of the card. Referring to FIG. 1C, information including a card number, a management number, and a valid term, which are allocated to a card during issuance, is stored in the memory of the card.

Card-approval-information of the card is stored in a predetermined region of memory (S160). In other words, card-approval-information and user attribute information are stored in a unit memory section corresponding to the management number of the card. For example, when a card to be issued is a fifth card, a start address of the memory area is “00000000”, and a size of a unit memory section in the memory area is 2 bits, a management number of the card is “5”. That is, a logical number of the card is “5”. When necessary values are applied to Formula (1), an actual address of the logical address “5” is calculated like Formula (2).
Actual address of logical address “5”=0+2(5−1)=8 (2)

That is, the actual address of the logical address “5” is “8”. Accordingly, the card-approval-information is stored in a 2-bit region starting from a point corresponding to the actual address “8”. The card-approval-information is commonly configured according to rules agreed with by all card companies. For example, rules can be made that a first bit indicates validity/non-validity of a card, a second bit indicates a user attribute, the card is recognized to be valid when the first bit is “1” and invalid when the first bit is “0”, and a card user is recognized to be a normal adult when the second bit is “1” and a student when the second bit is “0”. According to these rules, card-approval-information can be configured, as shown in FIG. 1D. When the card-approval-information shown in FIG. 1D is interpreted according to the rules, the card is valid and a user of the card is a student. The user attribute needs to be stored in the card-approval-information because an adult fare and a student fare are different in a transport fare (for example, a bus fare or a subway fare) system.

After card-approval-information of all cards to be initially issued or reissued is stored, a card-approval-information download message is generated (S170) and transmitted to a predetermined system and terminal apparatuses which require the card-approval-information (S180). As shown in FIG. 1E, the card-approval-information download message may include a start address of a memory area having a predetermined size and including a plurality of unit memory sections and data stored in the memory area. Alternatively, as shown in FIG. 1F, the card-approval-information download message may include a start address of a memory area having a predetermined size and including a plurality of unit memory sections, a difference value between the start address and a logical address of a unit memory section in which data is changed, and the changed data. Preferably, the card-approval-information download message having a format shown in FIG. 1E is used for initial data transmission, and the card-approval-information download message having a format shown in FIG. 1F is used when there is a change in stored data.

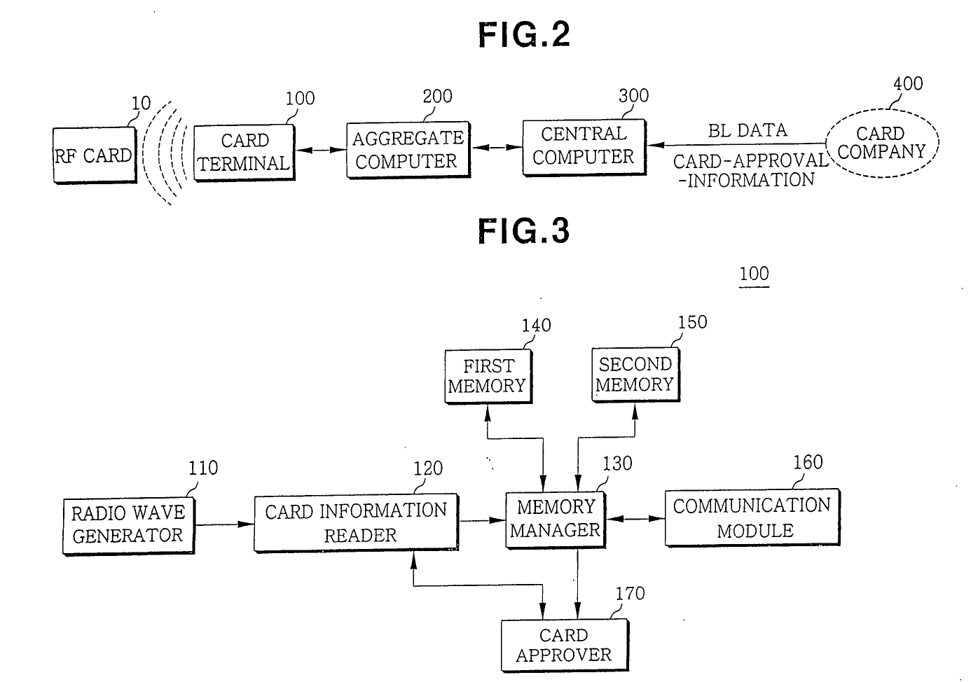

FIG. 2 is a block diagram of a credit-card system according to an embodiment of the present invention. Referring to FIG. 2, the credit-card system includes a card terminal 100, an aggregate computer 200, and a central computer 300.

The central computer 300 is connected to a server system of a card company 400 through Internet or a private line. The central computer 300 receives poor credit information (i.e., black list (BL) data) and card-approval-information having a memory address from the server system and stores and manages them in a separate storing place. The poor credit information indicates BL data including card numbers of cards having a poor credit history. The card-approval-information having the memory address has been described above with reference to FIGS. 1 through 1F.

The aggregate computer 200 is connected to the central computer 300 and the card terminal 100 through the Internet or the private line. The aggregate computer 200 receives the BL data and the card-approval-information having the memory address from the central computer 300, stores and manages them in a separate storing place, and transmits them to the card terminal 100. In addition, the aggregate computer 200 transmits the result of processing performed by the card terminal 100 to the central computer 300.

The card terminal 100 receives the BL data and the card-approval-information having the memory address from the aggregate computer 200 and stores and manages them in a separate storing place. In addition, the card terminal 100 generates radio waves, communicates with a radio frequency (RF) card 10 approaching within a predetermined distance therefrom using the radio waves, and determines validity/non-validity of the RF card 10 based on the BL data, the card-approval-information, and card information obtained via the communication with the RF card 10.

The aggregate computer 200 may be omitted according to an ambient environment such as a scale of the entire credit-card system.

FIG. 3 is a block diagram of the card terminal 100 of the credit-card system according to the embodiment of the present invention. Referring to FIG. 3, the card terminal 100 includes a radio wave generator 110, a card information reader 120, a memory manager 130, a first memory 140, a second memory 150, a communication module 160, and a card approver 170.

The communication module 160 performs data communication with an apparatus (for example, the aggregate computer 200 or the central computer 300) connected to the card terminal 100. The first memory 140 stores and manages card-approval-information having a memory address. The card-approval-information is transmitted from the aggregate computer 200 or the central computer 300 through the communication module 160. In order to store and manage the card-approval-information, the first memory 140 divides an entire memory area into unit memory sections having a predetermined size and allocates a logical address to each unit memory section.

The radio wave generator 110 generates and radiates radio waves outside and communicates with at least one card approaching within a predetermined distance therefrom using the radio waves. In addition, the radio wave generator 110 transmits information, which is received from the card as the result of communication, to the card information reader 120.

The card information reader 120 decodes the information received from the card through the radio wave generator 110 to read card information including a card number and a management number which are allocated during issuance, a valid term, and a usable amount and then transmits at least one of the card number and the management number to the memory manager 130. The reason at least one of the card number and the management number is transmitted to the memory manager 130 is because a certain type of card (for example, a Kookmin credit card) does not have a management number.

The memory manager 130 manages data stored in the first memory 140 and data stored in the second memory 150 according to information received from the aggregate computer 200 or the central computer 300 through the communication module 160. For example, when the card-approval-information having the memory address is received through the communication module 160, the memory manager 130 calculates a logical address of the first memory 140 in which the card-approval-information is to be stored by applying the start address of the memory area in a card company, the start address being included in the card-approval-information, to a predetermined algorithm and then stores the card-approval-information in a region corresponding to the logical address in the first memory 140. When the BL data is received through the communication module 160, the memory manager 130 stores the BL data in the second memory 150.

In addition, the memory manager 130 extracts card-approval-information and BL data, which correspond to card information read by the information reader 120, from the first memory 140 and the second memory 150. For example, when a management number is received from the card information reader 120, the memory manager 130 calculates a logical address of the first memory 140 by applying the management number to a predetermined algorithm, extracts card-approval-information stored in a region corresponding to the logical address from the first memory 140, and transmits the extracted card-approval-information to the card approver 170. When only a card number is received from the card information reader 120, the memory manager 130 determines whether the card number is included in the BL data stored in the second memory 150 and transmits the result of the determination to the card approver 170.

The card approver 170 determines whether a card approaching the radio wave generator 110 is valid based on card-approval-information and BL data, which are extracted by the memory manager 130, and card information read by the card information reader 120. More specifically, the card approver 170 primarily determines whether the card is valid based on the card-approval-information and the BL data received from the memory manager 130 and secondarily determines whether the card is valid based on a valid term and a usable amount received from the card information reader 120. In other words, even if it is determined that the card is valid based on information received from the memory manager 130, when the valid term is expired or when the usable amount is less than the amount of settlement, the card is determined as invalid.

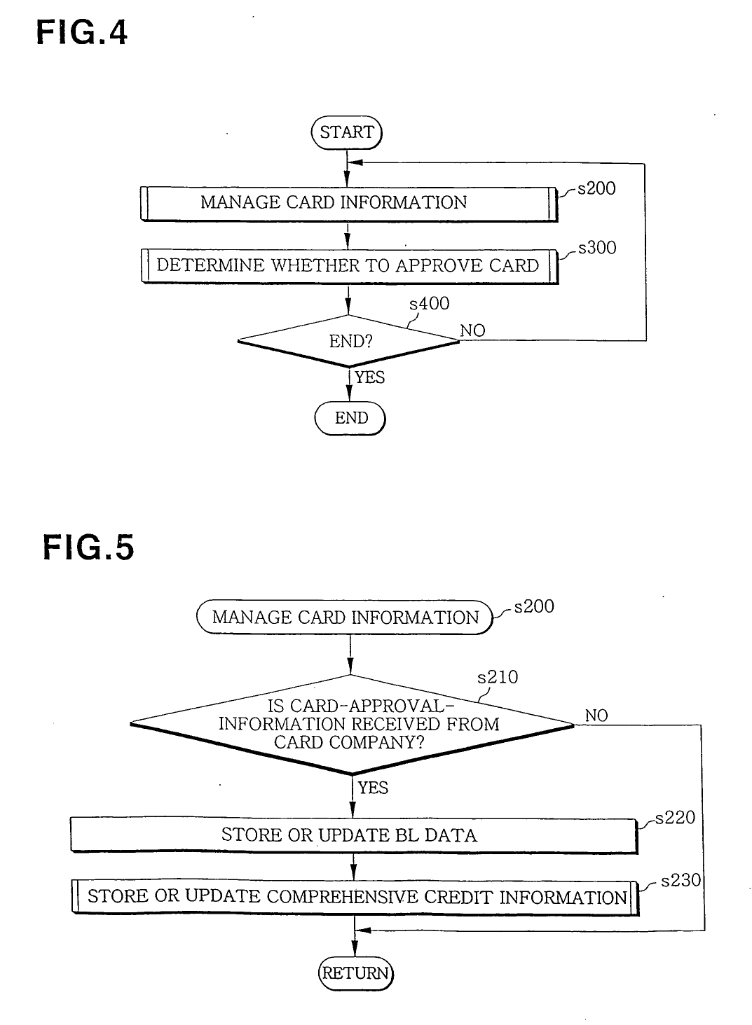

FIGS. 4 through 7 are flowcharts showing an operation of a card terminal according to the embodiment of the present invention.

Referring to FIG. 4, the card terminal manages card-approval-information received from a card company (S200) and determines whether to approve a card approaching within a predetermined distance therefrom (S300).

FIG. 5 shows a flowchart of step S200. Referring to FIG. 5, when the card terminal receives card-approval-information from a card company (S210), the card terminal determines a type of the card-approval-information and when the type of the card-approval-information is BL data, stores or updates the BL data in a BL data storage area (S220). When the type of the card-approval-information is comprehensive credit information including both valid and invalid card information, the card terminal stores or updates the comprehensive credit information in a comprehensive credit information storage area (S230). The comprehensive credit information corresponds to card-approval-information having a memory address.

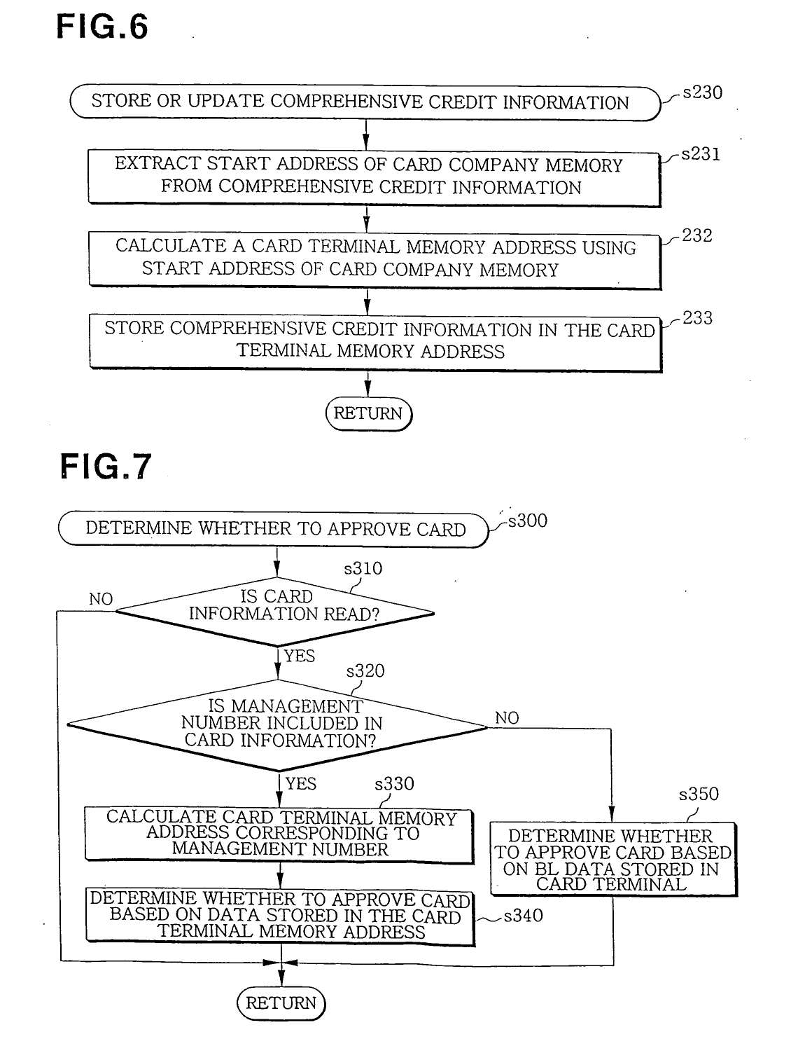

FIG. 6 is a flowchart of step S230 shown in FIG. 5. Referring to FIG. 6, a start address of a card company memory is extracted from the comprehensive credit information received from the card company (S231). Next, a card terminal memory address, in which the comprehensive credit information is to be stored in the card terminal, is calculated using the start address of the card company memory (S232). Preferably, the card terminal memory address is calculated using a formula differently predetermined depending on the memory characteristics of the card terminal. Thereafter, the comprehensive credit information is stored in the card terminal memory address (S233).

FIG. 7 shows a procedure in which the card terminal determines whether to approve the card in step S300. Referring to FIG. 7, when card information is read from the card approaching the card terminal (S310), it is determined whether a management number is included in the card information, (S320). The management number indicates a memory address in which the card-approval-information is stored. If it is determined that the management number is included in the card information in step S320, a card terminal memory address corresponding to the management number (i.e., the memory address) is calculated (S330), and then whether to approve the card is determined based on data stored in the card terminal memory address (S340). However, if it is determined that the management number is not included in the card information in step S320, whether to approve the card is determined based on the BL data stored in the card terminal (S350). In other words, whether to approve the card is determined according to whether a card number is included in the BL data.

The above description just concerns embodiments of the present invention. The present invention is not restricted to the above embodiments, and various modifications can be made thereto within the scope defined by the attached claims. For example, the shape and structure of each member specified in the embodiments can be changed.

### INDUSTRIAL APPLICABILITY

According to the present invention, card-approval-information is generated and managed using a management number (for example, an Alias number) which is allocated to a card by a card company during issuance, so that the length of the card-approval-information can be remarkably reduced. Accordingly, memory of a credit-card system, which periodically or non-periodically receives card-approval-information and uses the card-approval-information to approve a card in real time, can be efficiently utilized. In addition, according to the present invention, time taken for transmitting the card-approval-information from the card company to the credit-card system can be reduced.

1. A method of managing card-approval-information using a memory address, the method comprising:
a first step of dividing a memory area, which has a predetermined size and used for storing card-approval-information and user attribute information, into a plurality of unit memory sections having a predetermined size and allocating a logical address to each of the unit memory section;
a second step of generating and allocating a unique card number to a card, selecting a logical address of each unit memory section in order, and allocating the selected logical address to the card as a management number, while initially issuing or reissuing the card;
a third step of generating a management table for managing a relationship between the management number and the card number and storing the management number and the card number in a memory chip of the card;
a fourth step of storing card-approval-information and user attribute information of the card in a unit memory section corresponding to the management number of the card; and
a fifth step of generating a card-approval-information download message including a start address of the memory area and data stored in the memory area and transmitting the card-approval-information download message to terminal apparatuses and a predetermined system, which require the card-approval-information.

2. The method of claim 1, wherein the first step comprises dividing the memory area into the plurality of unit memory sections, each of which has a size of 2 bits and is composed of a 1-bit region in which the card-approval-information is stored and a 1-bit region in which the user attribute information is stored.

3. The method of claim 1, wherein the fifth step comprises when transmitting changed card-approval-information to the predetermined system and the terminal apparatuses, generating the card-approval-information download message including the start address of the memory area, a difference value between the start address and a logical address of a unit memory section storing the changed card-approval-information, and the changed card-approval-information.

4. A credit-card system using card-approval-information having a memory address, the credit-card system comprising:
a central computer, which is connected to a server system of a card company through Internet and/or a private line, receives poor credit information and card-approval-information having a memory address from the server system, and stores and manages them in a separate storage place; and
a card terminal, which receives the poor credit information and the card-approval-information having the memory address from the central computer, stores and manages them in a separate storage place, generates radio waves to communicate with a card approaching within a predetermined distance therefrom, and determines validity or invalidity of the card approaching thereto based on the poor credit information, the card-approval-information having the memory address, and card information obtained via the communication with the card.

5. The credit-card system of claim 4, further comprising an aggregate computer, which is connected to the central computer and the card terminal through the Internet and/or the private line, receives the poor credit information and the card-approval-information having the memory address from the central computer, stores and manages them in a separate storage place, transmits them to the card terminal, and transmits a result of processing performed by the card terminal to the central computer.

6. The credit-card system of claim 4, wherein the card terminal comprises:
a communication module, which performs data communication with the aggregate computer and the central computer;
a first memory, which stores and manages the card-approval-information having the memory address received from the aggregate computer and the central computer through the communication module;
a second memory, which stores and manages the poor credit information received from the aggregate computer and the central computer through the communication module;
a radio wave generator, which generates and radiates the radio waves outside and communicates with at least one card approaching within the predetermined distance therefrom using the radio waves;
a card information reader, which reads information received from the card through the radio wave generator;
a memory manager, which manages data stored in the first memory and the second memory based on information transmitted from the aggregate computer and the central computer through the communication module and extracts poor credit information and card-approval-information having a memory address from the first memory and the second memory based on the card information read by the card information reader; and
a card approver, which determines validity or invalidity of the card approaching the radio wave generator based on the poor credit information and the card-approval-information having the memory address extracted by the memory manager and the card information read by the card information reader.

7. The credit-card system of claim 6, wherein the first memory divides its entire memory area into a plurality of unit memory sections having a predetermined size and allocates a logical address to each of the unit memory sections to store and manage the card-approval-information having the memory address.

8. The credit-card system of claim 6, wherein the card information reader reads the card information including a card number and a management number which are allocated during issuance of the card, a valid term, and a usable amount and then transmits at least one of the card number and the management number to the memory manager.

9. The credit-card system of claim 8, wherein when the card-approval-information having the memory address is received through the communication module, the memory manager calculates a logical address of the first memory, in which the card-approval-information is to be stored, by applying a start address of a memory area in the card company, the start address being included in the card-approval-information, to a predetermined algorithm and then stores the card-approval-information in a region corresponding to the logical address in the first memory, and
when the management number is received from the card information reader, the memory manager calculates a logical address of the first memory, in which card-approval-information corresponding to the management number is stored, by applying the management number to a predetermined algorithm, extracts the card-approval-information stored in a region of the first memory corresponding to the logical address, and transmits the card-approval-information to the card approver.

10. The credit-card system of claim 8, wherein when the poor credit information is received, the memory manager stores the poor credit information in the second memory, and
when the management number is not received from the card information reader but the card number is received from the card information, the memory manager determines whether the card number is included in the poor credit information stored in the second memory and transmits a result of the determination to the card approver.

11. The credit-card system of claim 6, wherein the card approver primarily determines whether the card is valid based on the card-approval-information and the poor credit information, which are received from the memory manager, and secondarily determines whether the card is valid based on a valid term and a usable amount, which are received from the card information reader, in order to determined validity or non-validity of the card.
